(19) United States
(12) Patent Application Publication
(10) Pub. No.: US 2013/0278866 A1
(43) Pub. Date: Oct. 24, 2013

(54) ILLUMINATION DEVICE AND LIQUID CRYSTAL DISPLAY APPARATUS USING THE SAME

(71) Applicant: HITACHI CONSUMER ELECTRONICS CO., LTD., Tokyo (JP)

(72) Inventors: Makoto TSUMURA, Hitachi (JP); Satoshi OUCHI, Kamakura (JP); Hidenao KUBOTA, Yokohama (JP); Masayuki TANABE, Oyama (JP)

(73) Assignee: HITACHI CONSUMER ELECTRONICS CO., LTD., Tokyo (JP)

(21) Appl. No.: 13/866,396

(22) Filed: Apr. 19, 2013

(30) Foreign Application Priority Data
Apr. 23, 2012 (JP) 2012-097255

(51) Int. Cl. G02F 1/1335; F21V 13/04

(52) U.S. Cl. CPC G02F 1/133602; F21V 13/04
USPC 349/67; 362/235

(57) ABSTRACT

A plurality of backlight blocks are configured by being juxtaposed in the plane direction of an illumination device and include a bidirectional backlight block. Light sources are formed on both lateral sides of the bidirectional backlight block in the direction of the axes of emission of the light sources, the light sources formed on one lateral side are arranged so that light is emitted in the direction toward the light sources formed on the other lateral side, the light sources formed on the other lateral side are arranged so that light is emitted in the direction toward the light sources formed on the one lateral side, and the bidirectional backlight block is arranged in the center part of the illumination device in the direction of the axes of emission of the light sources.

### BACKGROUND OF THE INVENTION

The present invention is concerned with an illumination device using, for example, a light-emitting diode (LED) as a light source and with a liquid crystal display apparatus using the same and pertains in particular to an illumination device that is capable of enhancing utilization efficiency of light from light sources to obtain high-quality images and a liquid crystal display apparatus using the same.

A liquid crystal display apparatus is used in various fields because it can be made thin and light-weighted. Since liquid crystals do not themselves emit light, there is arranged an illumination device (hereinafter also called a “backlight”) on the back face of a liquid crystal display panel. For a liquid crystal display apparatus having a relatively large screen such as a television display device, fluorescent tubes have been used as light sources. However, since fluorescent tubes have mercury vapor sealed inside, impact on the global environment is large; particularly in Europe and the like, there is a trend that its use is forbidden. Also, in order to cope with regulations or demands of electric energy conservation, reductions in electric power consumption are requested also in illumination devices for liquid crystals.

Accordingly, use of light-emitting diodes (LEDs) as light sources of the backlight instead of fluorescent tubes is carried out. Liquid crystal display apparatuses using LED light sources are increasing from year to year even in large-sized display apparatuses such as television sets. Although an illumination device of a liquid crystal display apparatus must be an area light source, an LED is a point light source. Consequently, an optics system forming an area light source from point light sources such as LED light sources (i.e. converting point light source into an area light source) is needed in a backlight of a liquid crystal display apparatus using LED light sources. As prior arts of optics systems for obtaining such area light sources, the followings are known.

For example, in JP-A-2006-236701, there is disclosed a configuration in which a light guide plate is arranged directly below a liquid crystal display panel, a line-shaped recess is formed in this light guide plate, and LED light sources of the side emission type are arranged in the recess in the line shape. Further in JP-A-2006-236701, there is disclosed a configuration of an optics system in which a side emission type LED is configured using an optical component making light from an LED light source be emitted from the lateral face of the LED light source, and a diffuse reflection domain having a function of diffuse reflection and a specular reflection domain having a function of specular reflection are formed in a reflective sheet part so that intentionally a prescribed fraction of light is reflected diffusely, increasing the utilization efficiency of light and reducing luminance non-uniformities.

Also, in order to implement electric energy conservation with a separate approach, area dimming (also called “area control” or “local dimming”) in which the backlight is divided up into a plurality of blocks and regulated per block has been progressively put into practice. As an area light source device having a large light-emitting area, a prior art in which the divided light guide blocks are arranged in tandem is known as being described, for example, in JP-A-11-288611. In there, it is shown that, in consideration of a difference in luminance between both ends and the center part of a fluorescent tube being as a primary light source arranged in each light guide block, overlap of mutually neighboring light guide blocks forms tongue-shaped overlapping portions in order to prevent occurrence of a lack of luminance due to electrode parts at both ends of the primary light source and, further, it is disclosed that the electrode parts of both ends of the primary light source are made to be curved and that these curved electrode parts are arranged outside the range of the light guide blocks.

In addition, in JP-A-2004-265635, there is disclosed to configure in combination of backlight units divided lengthwise and breadthwise in a backlight in a large-sized liquid crystal display and, further, in order to prevent luminance non-uniformities from generating in the joining parts of the respective backlight units, interposing a transparent acrylic plate or maintaining a necessary space between a backlight including a light guide plate and a set of a diffusion plate and a liquid crystal panel.

Also, in JP-A-2002-082626, it is disclosed that both ensuring center luminance and a reduction in electric power consumption are accommodated with each other by means of arranging light sources of the fluorescent tube type with a narrower pitch toward the center in the vertical direction.

### SUMMARY OF THE INVENTION

As for the backlight related with the aforementioned prior arts, there is chosen a configuration in which, using light guide plates in units of blocks or backlight units, the light is guided to the liquid crystal side as propagating it in a horizontal direction and emitted. Because of this, optical parts such as light guide plates become additionally necessary so that there arises a cost increase due to increase of optical parts and a rise in the number of parts for positioning and holding thereof, and also structural means for holding light guide plates and the like become necessary.

Also, on the occasion of arranging optical components such as the light guide plates of the blocks or the backlight units, there is a possibility that positional misalignment or the like occurs. If positional misalignment occurs, there arise things like leaking light from the borders of respective blocks or backlight units to form bright lines or, on the contrary, lacking light to form dark lines so that a disadvantage arises that the spatial distribution of the emitted light of the backlight becomes non-uniform or that so-called luminance non-uniformities occur. In order to avoid such the disadvantage, in the prior arts described in JP-A-11-288611 and JP-A-2004-265635, there was a need for using a special structure as carrying out machining of adjacent light guide blocks, modifying the shapes of the light emission, sources, or additionally installing an acrylic plate for diffusion in the upper part of the light guide plate. Further, in these prior arts, since the luminance is devised to become uniform regarding the interior of a block, there was the problem of the luminance lines on the borders becoming conspicuous on the contrary.

In addition, in the prior art described in JP-A-2006-236701, there is a need to form a diffuse reflection domain having a function of diffuse reflection and a specular reflection domain having a function of specular reflection in the reflective sheet part and, therefore, there is a problem such that, while complex optical design is necessary, there is simultaneously a constraint in making it thinner; there is no description of this problem in JP-A-2006-236701.

Also, in the prior art described in JP-A-2002-082626, since a light source of the fluorescent tube type is utilized, it is a light source that radiates light isotropically with respect to the central axis of the fluorescent tube. Consequently, there was a problem that sufficient performance could not be ensured with a configuration implementing area dimming in a thin construction.

The present invention is to provide a technology capable of enhancing the utilization efficiency of the light from the light source and obtaining appropriate light output (for example, symmetry in luminance) in an illumination device utilizing area dimming while being of a simple configuration of an illumination device and a liquid crystal display apparatus using the same.

Also, the present invention makes a reduction in electric energy consumption and enhancement of luminance at the center of the screen, to which a viewer pay attention in higher degree, consistent with each other by controlling the luminance profile in the vertical direction in an illumination device of the air light guide method using LED light sources of a side view structure.

The characteristics of the present invention for resolving the aforementioned problems are, for example, as follows.

An illumination device including: a plurality of light sources having axes of light emission in a direction parallel to a plane of light irradiation of the illumination device, arrayed in a direction perpendicular to the axes of light emission; a reflective component reflecting emitted light from the plurality of the light sources; an optical element of a plate shape, arranged to be separated by air from the reflective component and guiding light from the plurality of the light sources toward the plane of light irradiation; a light control component, provided on a back surface or a front surface of the optical element, and controlling or adjusting an amount of light emission from the plurality of the light sources; and a plurality of backlight blocks, the plurality of the backlight blocks being configured by being juxtaposed in a plane direction of the illumination device, the plurality of the backlight blocks including a bidirectional backlight block; wherein the light sources are formed on both lateral sides of the bidirectional backlight block in a direction of the axes of emission of the light sources; wherein the light sources formed on one lateral side of the bidirectional backlight block are arranged so that light is emitted therefrom in a direction toward the light sources formed on another lateral side of the bidirectional backlight block; wherein the light sources formed on the other lateral side of the bidirectional backlight block are arranged so that light is emitted therefrom in a direction toward the light sources formed on the one lateral side of the bidirectional backlight block; and wherein the bidirectional backlight block is arranged in a center part of the illumination device in a direction of the axes of emission of the light sources.

In the foregoing, an illumination device, wherein the plurality of the backlight blocks further include a unidirectional backlight block; wherein the light sources are formed on both lateral sides of the unidirectional backlight block in a direction of the axes of emission of the light sources; wherein the light sources formed on one lateral side of the unidirectional backlight block are arranged so that light is emitted therefrom in a direction toward the light sources formed on another lateral side of the unidirectional backlight block; wherein the light sources formed on the other lateral side of the unidirectional backlight block are arranged so that light is emitted therefrom in an opposite direction to a direction toward the light sources formed on the one lateral side of the unidirectional backlight block; and wherein 2 D>D_{c}>D is satisfied where a pitch of arrangement of the light sources in the bidirectional backlight block is D_{c} and a pitch of arrangement of the light sources in the unidirectional backlight block is D.

In the foregoing, an illumination device, wherein 1.6 D>D_{c}>1.2 D is satisfied.

An illumination device including: a plurality of light sources having axes of light emission in a direction parallel to a plane of light irradiation of the illumination device, arrayed in a direction perpendicular to the axes of light emission; a reflective component reflecting emitted light from the plurality of the light sources; an optical element of a plate shape, arranged to be separated by air from the reflective component and guiding light from the plurality of the light sources toward the plane of light irradiation; a light control component, provided on a back surface or a front surface of the optical element, and controlling or adjusting an amount of light emission from the plurality of the light sources; a plurality of backlight blocks, the plurality of the backlight blocks being configured by being juxtaposed in a plane direction of the illumination device; and wherein a distribution of emitted light of the illumination device is made to be line symmetric with respect to a virtual line segment perpendicular to the axes of emission of the light sources and passing through a center of the illumination device by changing respective amounts of emitted light of the plurality of the backlight blocks.

In the foregoing, an illumination device, wherein the respective amounts of emitted light of the plurality of the backlight blocks by changing either a number of the light sources arranged in a direction perpendicular to the axes of emission of the light sources or applied electric power to the light sources constituting each of the plurality of the backlight blocks.

In the foregoing, an illumination device, wherein a pulse width of power-on is controlled to change the applied electric power to the light sources.

In the foregoing, an illumination device, wherein optical patterns of bright luminance parts, dark luminance parts, and intermediate luminance parts are arranged on the back surface or the front surface of the optical element corresponding to each of the plurality of the backlight blocks.

In the foregoing, an illumination device, wherein the reflective component includes a flat portion and 5 Lₕ>h>1.2 Lₕ is satisfied where a distance between the optical element and the flat portion of the reflective component is h and a height of the light sources is Lₕ.

In the foregoing, an illumination device, further including a light source substrate on which the light sources are mounted, the light sources being mounted on an edge portion of the light source substrate in a direction of the axes of emission of the light sources.

In the foregoing, an illumination device, wherein the reflective component includes an inclined portion which is inclined from a top surface of the light source substrate toward a bottom surface of the illumination device.

A liquid crystal display device including a liquid crystal display panel and any one of the aforementioned illumination devices.

According to the present invention, the utilization efficiency of the light from the light sources is enhanced even having a simple configuration so that it becomes possible to form it thin and to obtain suitable light output (for example, luminance symmetry). Problems, configurations, and effects, other than those mentioned above, will be made clear from the description of the embodiments hereinafter.

### BRIEF DESCRIPTION OF THE DRAWINGS

FIG. 1 is an exploded view showing a schematic of an overall configuration of a liquid crystal display (LCD) having an illumination device according to an embodiment of the present invention;

FIG. 2 is a cross sectional view of the illumination device according to the present embodiment;

FIG. 3 is a cross sectional perspective view of a liquid crystal display including a backlight block showing the internal configuration of the backlight block according to the present embodiment;

FIGS. 4A and 4B are diagrams showing formation examples of a pattern according to the present embodiment;

FIG. 5 is a cross sectional view of the illumination device and the peripheral portions thereof according to the present embodiment in a direction perpendicular to the optical axes of light sources 7 and the backlight irradiating face;

FIG. 6 is an explanatory diagram showing by respective backlight blocks a formation example of patterns for generating a brightness and darkness distribution of luminance from the liquid crystal display in the interior of the backlight block;

FIG. 7 is a partial enlarged view of FIG. 6;

FIG. 8A is a plan view of an illumination device according to the present embodiment;

FIG. 8B is a plan view of the illumination device according to the present embodiment;

FIG. 9 is a characteristic graph showing the effects of the illumination devices according to the present embodiment;

FIG. 10 is an explanatory graph showing the applied electric power on the backlights according to a present embodiment; and

FIG. 11 is a characteristic graph showing the light output characteristics of the illumination device according to the present embodiment.

### DESCRIPTION OF THE EMBODIMENTS

Hereinafter, modes for implementing the present invention are described by means of specific embodiments, but the present invention is not to be limited hereto. Also, the diagrams according to the embodiments are schematic diagrams and are not to ensure accuracies in the positional relationships, the dimensions, and the like in the diagrams. Within the scope of the technical ideas disclosed in the present specification, various modifications and revisions by a person skilled in the art are possible. Also, in all the drawings for describing the present invention, the same reference numerals are put to items having the same functions, and a repeated description thereof may be omitted.

### Embodiment 1

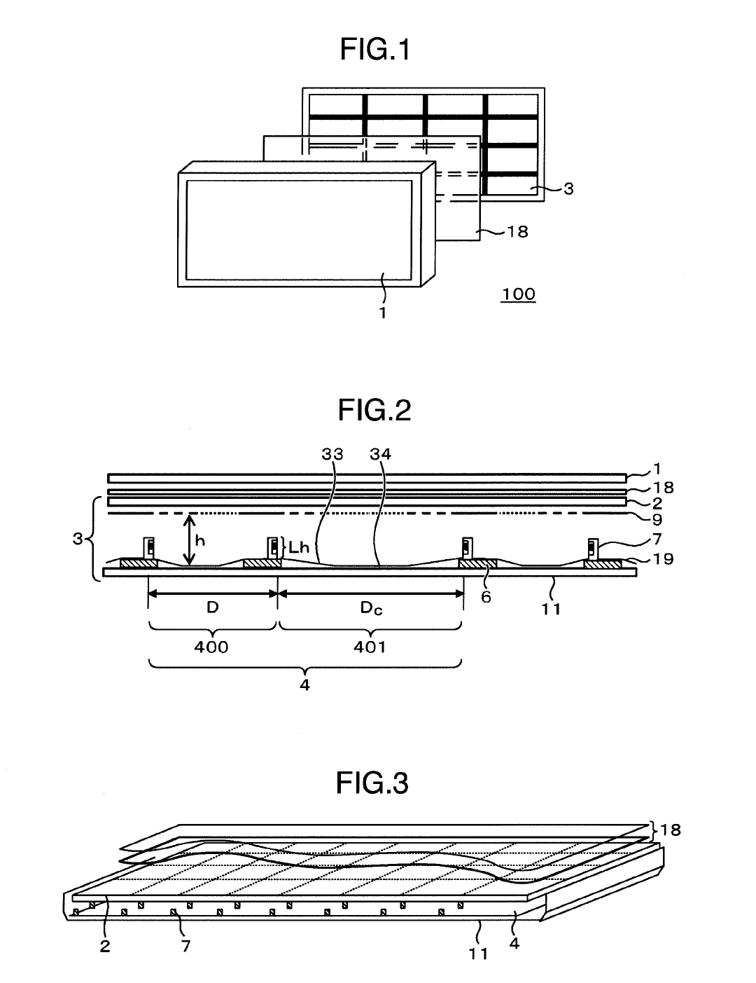

First, regarding an overall configuration in which an illumination device according to the present embodiment is applied to an image display apparatus, a schematic thereof is described with reference to FIG. 1 to FIG. 3. FIG. 1 is an exploded view showing a schematic of an overall configuration of a liquid crystal display (LCD) having an illumination device according to an embodiment of the present invention, FIG. 2 is a cross sectional view of an illumination device according to the present embodiment, which is perpendicular to a light irradiating face thereof and parallel to the direction of the optical axes of the LEDs, and FIG. 3 is a cross sectional view of a liquid crystal display including a backlight block showing the internal configuration of the backlight block according to the present embodiment.

As shown in FIG. 1, a transmission-type liquid crystal display (LCD) 100 using a liquid crystal panel 1 that prevails as a display for displaying images is provided, as an overall configuration thereof, with a liquid crystal panel 1, an optical sheet group 18 including a diffuser panel, a diffusion sheet, a polarizing plate or sheet, a deflecting film, and the like, and an illumination device 3. An illumination device 3 according to the present embodiment is formed as combining and arranging a plurality of backlight blocks 4 in a matrix form on a plane (in a direction of a light irradiating face of the illumination device) as shown, for example, in FIG. 2 and devised to obtain suitable light output (for example, luminance symmetry) in a large-sized illumination device 3. In other words, the plurality of backlight blocks 4 are configured as being juxtaposed in the face direction of the illumination device 3.

In the liquid crystal display 100, in order to radiate light from the back face side of the liquid crystal panel 1, the illumination device 3 is necessary; this illumination device 3 may, according to the structure thereof, be a direct scheme, a side-light (edge-light) scheme, or a hybrid scheme combining the direct scheme and the side-light scheme. This hybrid scheme designates a structure in which a backlight is divided optically into a plurality of backlight blocks and light intensities are individually controlled, namely area-controlled. The hybrid scheme may also be called a slim-block scheme. The illumination device 3 according to the embodiment of the present invention is one that it is applicable to the slim-block scheme and is particularly one that adopts light sources of the side-view method and is applicable to a structure in which the backlight is divided up into a plurality of backlight blocks 4.

The illumination device 3 according to the present embodiment is, as shown in FIG. 2, arranged on the back face side of the liquid crystal panel 1 in order to radiate light on the liquid crystal panel 1 and has: light sources 7 including LEDs, lasers, arc tubes, or the like having a light emission axis (an optical axis) that is parallel to at least a horizontal direction (a direction of the face of the liquid crystal panel or of the light irradiating face of the illumination device); a reflective sheet 19 that reflects light from the light sources and is a sheet-shaped reflective component; and a plate-shaped optical element 2 which is provided to oppose to the reflective sheet 19 and arranged away with a prescribed spacing from the reflective sheet 19 for guiding the light from the light sources 7 and the reflective sheet 19 toward the liquid crystal panel 1. Here, the light sources 7 are taken to be side-view type LEDs emitting light in a direction parallel to planes of electrodes. Hereinafter, there are also cases where the light sources 7 are called “LED(s) 7”. Also, the reflective sheet 19 is provided so that at least a part thereof makes contact with a chassis 11 and LED substrates (light source substrates) 6 positioned on the bottom face side of the illumination device 3. Also, the light sources 7 are mounted on the LED substrates 6.

Here, in the configuration example shown in FIG. 2, the backlight blocks 4 are formed so that the shape viewed from the light irradiating face side of the illumination device 3 is a rectangular shape and the light from LEDs 7 advances in the longitudinal direction thereof and is reflected on the back face (the side of the reflective sheet 19) of the backlight blocks 4 for the light to travel to the liquid crystal panel 1. The backlight blocks 4 are comprised of a bidirectional backlight block 401 and a unidirectional backlight block 400.

In FIG. 2, the vicinity of the substantially center part in the horizontal orientation of the illumination device 3 is described. In the present embodiment, the left-hand side LEDs 7 are arranged to emit light in the right direction and the right-hand side LEDs 7 are arranged to emit light in the left direction with the bidirectional backlight block 401 at the center. In other words, in the direction of the emission axes of the light sources 7, the light sources 7 are formed on both the lateral sides of the bidirectional backlight block 401, the light sources 7 formed on one lateral side of the bidirectional backlight block 401 are arranged so that the light is emitted in the direction toward the light sources 7 formed on the other lateral side of the bidirectional backlight block 401, the light sources 7 formed on the other lateral side of the bidirectional backlight block 401 are arranged so that light is emitted in the direction toward the light sources 7 formed on the one lateral side of the bidirectional backlight block 401, and the bidirectional backlight block 401 is arranged in the center part of the illumination device 3 in the direction of the emission axes of the light sources 7. Also, as for the unidirectional backlight block 400, the light sources 7 are formed on both the lateral sides in the direction of the emission axes of the light sources 7 in the same way as the bidirectional backlight block 401, but in the unidirectional backlight block 400, the light sources 7 formed on one lateral side of the unidirectional backlight block 400 are arranged so that light is emitted in the direction toward the light sources 7 formed on the other lateral side of the unidirectional backlight block 400 and the light sources 7 formed on the other lateral side of the unidirectional backlight block 400 are arranged so that light is emitted in the opposite direction to the direction toward the light sources 7 formed on the one lateral side of the unidirectional backlight block 400.

Further, it is so arranged that a relationship between an arrangement pitch D_{c} between the LEDs of the bidirectional backlight block 401 and an arrangement pitch D between the LEDs of an adjacent unidirectional backlight block 400 is made to adopt unequal pitches of 2 D>D_{c}>D.

In the present embodiment, the bidirectional backlight block 401 mutually facing with D_{c}=1.6 D is arranged with a portrait configuration in the vicinity of the center of the horizontal orientation in the illumination device 3; using a landscape mounting substrate, however, it is possible to arrange it in the vicinity of the center of the vertical orientation in the illumination device 3.

Since the aforementioned LEDs 7 have a side-view structure, they are excellent for light propagation in the forward direction; by providing the LEDs 7 in a facing arrangement, light is radiated from the both sides of the bidirectional backlight block 401 and the luminance is significantly enhanced than that in the surrounding unidirectional backlight blocks 400. Further, by reducing the size of the bidirectional backlight block 401, that is the arrangement pitch of the LEDs 7, more from 1.6 D, it is possible to further strive for luminance enhancement, but, since a step in luminance is generated in the vicinity of the border with another unidirectional backlight block 400 when the pitch is made extremely short, it is desirable to set the pitch to be greater than 1.2 D, and preferably around 1.4 D. Like the present embodiment, by putting the LEDs 7 of the side-view structure in a facing arrangement and making the arrangement pitch of the LEDs 7 be different from that of the other backlight blocks, it is possible to enhance the luminance of the vicinity of the center which attracts a high degree of attention of humans without increasing the electric power consumption of the entire backlight. Also, since on the both sides of the bidirectional backlight block 401 unidirectional backlight blocks 400 with a normal backlight block arrangement pitch are adjacent, a disadvantage like a step in luminance would not be generated. By appropriately selecting the size D_{c} of the bidirectional backlight block 401, it is also possible to easily restrain steps in luminance within the bidirectional backlight block 401.

A plurality of the LEDs 7 are arrayed with suitable spacings on the short sides of the backlight blocks 4 (in the direction perpendicular to the sheet of paper in FIG. 3). It is also acceptable to array the LEDs 7 on the long sides of the backlight blocks 4. In particular, in the case where light propagation in the lateral direction is good rather than in the direction of light emission of the LEDs 7 due to a combination of a light control component 9, the reflective sheet 19, and the LEDs 7, the lengthwise and breadthwise LED arrangements in the backlight blocks 4 and matching of the light distribution characteristics are enhanced by arranging the LEDs 7 on the long sides so that an enhancement of the light utilization efficiency can be plotted. If the block size is the same, comparing with a backlight configuration to the scheme with the light guide plate, it is desirable for the present invention which takes light guidance through air as a basic principle that the arrangement pitch of the LEDs 7 is widened to about twice that of the scheme with the light guide plate. Incidentally, in the present embodiment, the light sources 7 are described as the LEDs 7 of the side-view type; laser light sources are also acceptable as far as they are point light sources. Also, it is possible to use linear light sources such as fluorescent tubes. Regarding the effects of changing the arrangement positions of the LEDs 7 from the short sides to the long sides, there is no difference in any way.

Further, in the present embodiment, the arrangement pitches of the LEDs 7 are taken to be of two kinds: the arrangement pitch Dc of the bidirectional backlight block 401 at the center part and the arrangement pitch D of the other, unidirectional backlight blocks 400; it is possible, however, to reduce electric power consumption and/or to enhance luminance characteristics by further increasing the number of pitch kinds due to various conditions such as desired luminance profile characteristics, the amount of LED light, or whether or not luminance control is performed for each LED array.

In the aforementioned illumination device 3, in a direction perpendicular to the light irradiating face and parallel to the optical axes of the LEDs 7, for example, a portion including one LED 7 (in reality, a plurality of the LEDs 7 are arrayed in the depthwise direction of the sheet of paper), an optical element 2, a reflective sheet 19, and the in-between space between the LEDs 7 is taken as a single backlight block 4 as shown in FIG. 2. And then, by individually controlling the LEDs 7 corresponding to the respective backlight blocks 4, it is possible to control the amount of light or the light intensity for each backlight block 4. Namely, configuring as described above in the present embodiment enables area control (local dimming).

As for the optical element 2, a diffuser panel, a transparent acrylic plate, a flat mirror plate, a diffuser panel with a micro pattern, an optical sheet, an optical characteristic control plate, a polarizing plate or sheet, or the like is used. On the back face of this optical element 2, there is provided a sheet-shaped light control component 9 to control or regulate the supply amount of light to the optical element 2 depending on the position of the optical element 2.

In the example of FIG. 2, there is provided a light control component 9 on the back face of the optical element 2 (in the direction in which the backlight blocks 4 are arranged with respect to the optical element 2); it may, however, also be provided on the front face of the optical element 2 (in the direction in which the liquid crystal panel 1 is arranged with respect to the optical element 2) or on both the back face and the front face thereof. This light control component 9 has a prescribed light control functions and the functions are at least two out of functions of reflecting, transmitting, diffusing, shading, absorbing, reemitting, coloring, wavelength-converting, and polarizing the prescribed amount of light two-dimensionally, for example. In this way, as for the light control component 9, a part of the incident light is transmitted and is emitted from the optical element 2 as scattered light in that location. Also, a part of the incident light is reflected by the light control component 9 and propagates in collaboration with the reflection function due to the aforementioned reflective sheet 19 in the direction of the optical axes of the light sources 7 inside the aforementioned space so that the light is guided and transmitted to far away from the light sources 7. Namely, the light control component 9, by transmitting a part of the light from the light sources 7 and the light reflected by the reflective sheet 19 and reflecting a part thereof and by carrying out these repeatedly along the direction of the optical axes, supplies sufficient light all the way to an edge portion of the backlight block 4 (the portion on the opposite side to the positions of the light sources 7). In this way, regardless of the sizes of the backlight blocks 4, a uniform luminance distribution and the utilization efficiency of the light can be enhanced.

However, there exists a maximum value of the efficiency due to means of light propagation in the pitch p of the LEDs determined from the sizes of the backlight blocks and the number of the LEDs constituting the blocks. In order to implement the aforementioned transmission and reflection of light, the light control component 9 is provided with slits and/or patterns.

As for the optical element 2 and the light control component 9, in particular the light control component 9, as moving away from the vicinity of the light sources 7 in the direction of the optical axes of the light sources 7, optical functions change such as the sizes and the shapes of the aforementioned slits and patterns, light transmittance, reflectance, diffusivity, capture rate, propagation rate, polarized light transmittance, color transmittance, and spectral separation. By this way, uniformity in the backlight blocks 4 can be readily implemented.

Here, letting a distance between the optical element 2 and flat parts of the reflective sheet 19 (i.e. a height of the aforementioned space) be h and a height of the LED 7 be Lₕ, a relationship between the distance h and the height Lₕ is preferable to be 5 Lₕ>h>1.2 Lₕ. By this way, it becomes possible to expand and diffuse the light leaking from the top face of the LED 7 and a hot spot (a portion where the light becomes bright locally) arising in the proximity of the light emission part of the LED 7 following the rule of the fourth power to the cosine of an angle (the 4th power rule) in the space of the height h so that they are made difficult to see as non-uniformities. It may also be said that the aforementioned condition determines a distance necessary for dimming light that transmits directly from the LED 7 through the light control component 9 when the side-view type LED 7 and the light control component 9 are too close.

As shown in FIG. 2, utilizing the thickness of the LED substrate 6, it is desirable, together with arranging the LED 7 in an edge portion of the LED substrate 6, to form an inclined portion 33 in the reflective sheet 19 inclined from the light emission face of the LED 7 (the top face of the LED substrate 6) toward the bottom face of the chassis 11 positioned between the LED substrates 6. In this way, since an image due to light emitted from the LED 7 is projected upward as being stretched out by the inclined portion 33 of the reflective sheet in the proximity of the LED 7, the light distribution of the reflected light is made parallel due to a tapered-edge effect based on the inclination, together with the light intensity being weakened. Also, by reducing irradiation luminance to the reflective sheet 19, a local intensity of radiated light on the optical element 2 due to this reflected light is reduced and equalized so that it is possible to greatly suppress generation of local high-luminance domains in the proximity of the LED 7, which is called a hot spot. Further, since the angle of incidence of the reflected light from the optical element 2 onto the flat part 34 of the reflective sheet 19 also becomes shallow, it becomes possible to guide the light from the light sources farther.

By providing the inclined part 33 from the face of the chassis 11 toward the LED substrate 6 to the reflective sheet 19 from the aforementioned flat part 34 up to the LED 7 of a next-stage, a high light extraction efficiency compensating for a shortage of the amount of light arising from the fact that it become further away from the LED 7 can be obtained since the angle of reflection from the face of the reflective sheet 19 becomes upward.

FIG. 3 is a schematic stereoscopic drawing of the backlight according to the present embodiment. Light sources 7 are arrayed together with a substrate (not illustrated) in a horizontal direction of the liquid crystal panel 1 on the metallic chassis 11 consisting of aluminum or the like, for example. The optical element 2 is arranged providing a prescribed distance with respect to the light sources 7. As for the optical element 2, a material such as a common diffuser panel, which is used in an illumination device 3 of a fluorescent-tube method such as CCFL (Cold Cathode Fluorescent Lamp), for example, can be used therefor. In this way, an illumination device 3 of the slim-block scheme can be implemented inexpensively.

Also, on the optical element 2, there is arranged the optical sheet group 18 such as prism sheets and/or brightness enhancement films so that luminance non-uniformities over the entire backlight irradiating face are reduced. In FIG. 3, the optical sheet group 18 includes a plurality of optical sheets, but there may be only one.

Incidentally, although dotted lines are drawn on the optical element 2 in FIG. 3, this is drawn to virtually subdivide the backlight blocks 4; it is not in the reality that the backlight blocks 4 are physically separated or that there are provided grooves or the like for subdividing the backlight blocks 4. In the present embodiment, the optical element 2 is taken to be composed of one plate-shaped component (a diffuser panel). As the need arises, on the front face (the side toward the liquid crystal panel 1) or the back face (the side toward the chassis 11) of the optical element 2 grooves or the like for subdividing the backlight blocks 4 may be provided.

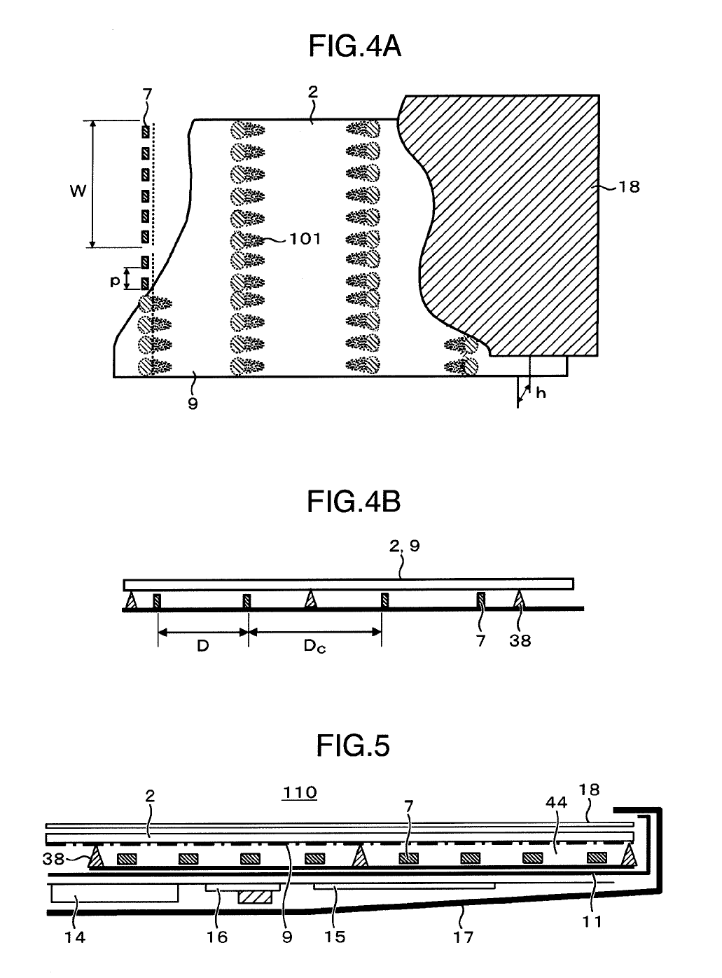

FIG. 4A and FIG. 4B show a top view and a sectional view of a schematic of the illumination device according to the present embodiment. In the example of FIG. 4A and FIG. 4B, there is provided a pattern 101 of a prescribed shape on the top face or the bottom face, or both, of the light control component 9 or the optical element 2. This pattern 101 is shown for the case of being viewed from the side of the liquid crystal panel 1. Incidentally, the “W” of FIG. 4A designates the width in the longitudinal direction (the dimension in a direction perpendicular to the direction of the optical axes of the light sources 7) of one backlight block and D represents the arrangement pitch of the unidirectional backlight blocks 400 in the lateral direction perpendicular thereto. Namely, in this example, there are provided six light sources 7 (side-view LEDs) in the backlight block. Of course, the number of the light sources 7 per backlight block is not limited thereto; the pitch p of the light sources in the case of constituting a unit backlight block from n light sources 7 becomes p=W/n where a distance between the light sources at the end parts of the n light sources 7 arranged in a direction perpendicular to the direction of the emission axes of the light sources 7 is taken to be W, and it is also acceptable for the number of the light sources to be 1.

In the present embodiment, in order to simplify the illustration, an array-shaped light source block which is longer in the lateral direction is arranged in the horizontal direction in a plan view; from the viewpoint of reducing the number of light source blocks and aiming for a cost reduction in components, however, it is preferable to arrange light source blocks which is wider in the longitudinal direction in the vertical direction in a plan view when it is applied to liquid crystal TV sets, which is generally wider in the longitudinal direction.

As illustrated, the pitch, the density, or the shape of the pattern 101 in the direction of the optical axes of the light sources 7 (the horizontal direction in the sheet of paper) changes with the distance from the light sources 7. On the other hand, the pitch, the density, or the shape of the pattern 101 in a direction perpendicular to the optical axes of the light sources 7 (the vertical direction in the sheet of paper) is substantially the same. More specifically, the pattern 101 is formed to be more elongated in the direction of light emission (the direction of the optical axes) of the light sources 7 than in the direction opposite to the direction of the optical axes. Also, the pattern 101 changes depending on the distance from the light sources 7 in the direction of the optical axes; as shown in FIG. 4A, for example, a shape that tapers off with the greater distance from the light source 7 in the direction of the optical axis, a shape combining an ellipse with its longitudinal axis in the direction of the optical axis of the light source 7 with an ellipse of a direction perpendicular to the direction of the optical axis, or a shape that widens with the greater distance from the light source 7 in the direction of the optical axis may be adopted.

The aforementioned pattern 101 is basically provided on the back face of the optical element 2, but it may be provided on the front face of the optical element 2. In addition, what is made by printing a pattern on a printing sheet, a thermal transfer sheet, a perforated reflective/transmissive sheet, a patterned reflective sheet, or an optical sheet may be attached in the proximities of the light sources 7 on the back face or the front face of the optical element 2, or on both of them as the pattern 101 to configure the pattern 101.

As the pattern 101, as long as it is capable of controlling or adjusting shading action, light transmission, light reflection, a propagation rate, or the like depending on the position (the distance from the light sources 7), any shape or any component may be adopted. For example, by gradually reducing the pattern density as moving away from the light sources 7 in the direction of the optical axes, transmitted light is increased in places far away from the light sources 7 while the transmitted light is set to be 10% or less as shading and reflection are increased in the vicinities of the light sources 7. In this way, it is possible to raise the amount of transmission as for not only the light traveling from the light sources 7 in the direction of the optical axes but also the light propagating two-dimensionally (radially) to increase the amount of emission of light toward the liquid crystal panel in accordance with the distance from the light sources 7. And, according to a configuration like this, luminance non-uniformities in the direction of the optical axes of the light sources 7 can be reduced and also it is possible to enhance luminance uniformity (luminance controllability) within the backlight blocks and in the entire backlight irradiating face.

The aforementioned pattern 101 can be constituted of an aggregate of minute dots as shown in FIG. 4A and the outer shape of this aggregate of the dots can be rendered to have various shapes such as a polka dot, a curve, a dotted line, radial straight lines, or radial curved lines. Also, in the dot aggregate, if the density of the dots is changed so as to gradually apply a gradation in the dot density with the distance from the light sources 7, it is possible to enhance error sensitivity due to positional misalignment between the light sources 7 and the pattern. In addition, in the case of forming the pattern by printing, it is possible to readily adjust an ink film thickness, an ink color (so that a gradation is applied by mixing blue and black to control the transmittance), a dot size, a dot shape, a pattern shape directly above the LEDs, and a printing thickness and formation of the outer shape and/or the gradation of the aforementioned dot aggregates can be carried out better. Consequently, when the pattern is formed by printing, the uniformity of the luminance can be further enhanced.

In FIG. 5, there is shown a cross sectional view of the illumination device according to the present embodiment and the peripheral portions thereof, taken perpendicular to the direction of the optical axes of the light sources 7 and the backlight irradiating face. As illustrated, between a back cover 17, which is the back face casing of a liquid crystal display apparatus 110, and the chassis 11, a signal control board 15, an LED drive circuit 16, and a power supply 14 are arranged. The signal control board 15, the LED drive circuit 16, and the power supply 14 are mounted on the chassis 11. The chassis 11 may be one onto which the aforementioned reflective sheet 19 is pasted. Also, by forming curved surfaces and/or inclined surfaces along the direction of the optical axes of the light sources 7 as introducing raising in press working on the chassis 11 with the reflective sheet 19 pasted thereon, the reflection angle of light on the reflective sheet 19 can be changed along the direction of the optical axes. This makes the light from the light sources 7 propagate readily in the direction of the optical axes thereof and there is the effect that the amount of light supply to the edge portions (the portions opposite to the positions of the light sources 7) of the backlight blocks 4 is further increased. In addition, since raising is added to the chassis 11, the mechanical strength of the chassis 11 is also increased.

Space between the reflective sheet 19 and the light control component 9 is maintained by cone-shaped pin molds 38 and a prescribed distance is secured. In this way, light is gradually emitted by the light control component 9 and the optical element 2 while the light is propagating inside the backlight blocks 4 so that collectively uniform light can be controlled in a unit of each backlight block.

Referring back to FIG. 2, the illumination device 3 according to the present embodiment basically comprises: the LEDs 7 as light sources installed on the LED substrates 6; the optical element 2 for effectively guiding light from the LEDs 7 to the liquid crystal panel 1; the reflective sheet 19 for supplying light to the optical element 2; and the space between the optical element 2 and the reflective sheet 19 for making light propagate favorably in the direction of the optical axes of the LEDs 7. On the back face of the optical element 2 provided toward the liquid crystal panel 1 of the space, the light control component 9 is provided; in this way, the light from the LEDs 7 is gradually emitted along the direction of the optical axes of the LEDs 7 and uniform light distributions of the backlight blocks 4 are implemented.

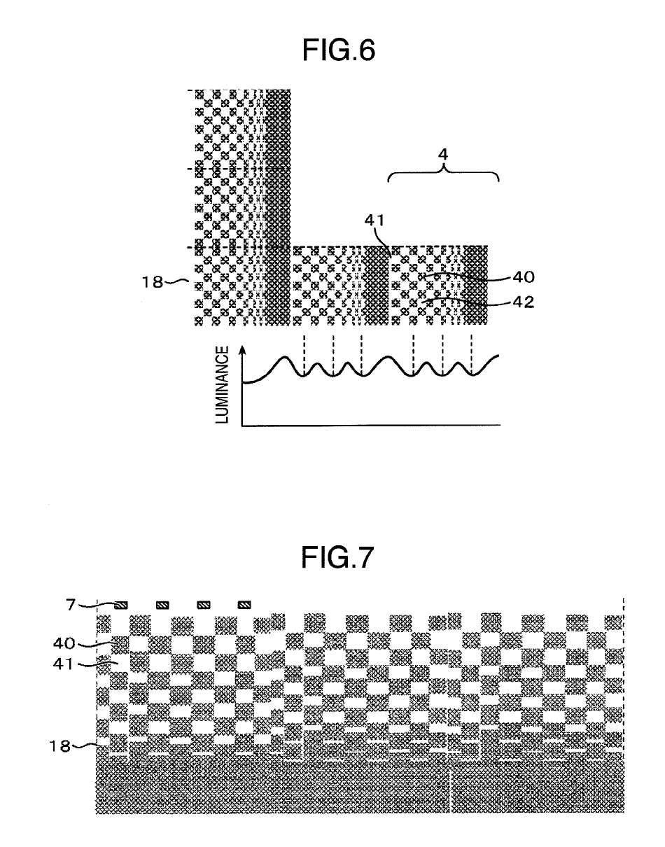

Next, a description is given with reference to FIG. 6 and FIG. 7 on technology to mitigate the difference in luminance between the luminance on the border of the backlight blocks and the luminance in the interior of the backlight blocks and to make the brightness difference at the borders inconspicuous in the illumination device according to the present embodiment. Here, the image of a space in which the backlight blocks 4 interconnects with each other in the direction of the optical axes of the LEDs 7 and a direction perpendicular to the direction of the optical axes is shown in FIG. 6.

FIG. 6 is a diagram that describes across a plurality of the backlight blocks an example of formation of patterns for intentionally generating a brightness/darkness distribution in the luminance from the illumination device according to the present embodiment, and FIG. 7 is a diagram describing a situation in which a luminance difference is generated between the borders of the backlight blocks and the interior of the backlight blocks regarding the luminance from the backlight device, by arraying a plurality of the backlight blocks. The pattern according to this embodiment is taken to be called a “contrast pattern”. In FIG. 6, the contrast pattern includes a bright luminance part 40, a dark luminance part 41, and an intermediate luminance part 42.

Incidentally, the aforementioned differences in luminance (the brightness/darkness differences in luminance or the luminance non-uniformities), here, are luminance differences when the light radiated from the illumination device 3 is observed from the light emission side of the optical sheet group 18 (refer to FIG. 2) including a diffuser panel and the like. Here, the pattern of the bright luminance part 40 is a pattern for which the action of diffusing light is greater (i.e. greater in roughness) than for the dark luminance part 41 and the intermediate luminance part 42, and the pattern of the intermediate luminance part 42 is a pattern for which the action of diffusing light is greater than for the dark luminance part 41. The pattern of the bright luminance part 40 can be implemented by providing fine roughness on the surface. In this case, it appears white to the human eye due to diffusion of light; it is shown in FIG. 6 with black and white reversed for easy perception of the presence/absence of the pattern.

As stated above, in the case of configuring the illumination device 3 by arraying a plurality of the backlight blocks 4 vertically and horizontally, light may leak from the borders of the backlight blocks 4 or from directly above the LEDs 7 to cause bright lines or hot spots and bright luminance parts 40 may be generated therefrom. Also, inversely, it is possible that, light becomes insufficient on the borders of the backlight blocks 4 or on the back face side of the LEDs 7 to develop dark lines.

Accordingly, in this example, in order for the light emitted from the light sources to be emitted uniformly (in a direction perpendicular to the drawing toward this side) in the interior of the backlight blocks 4, that is for the luminance to become uniform, optical patterns such as the bright luminance part 40, the dark luminance part 41, and the intermediate luminance part 42 of the figure are arranged on the back face and/or the front face of the optical element 2 or in the proximity of the back face, corresponding to each of a plurality of the backlight blocks 4. FIG. 6 illustrates patterns arranged on the back face. The pattern density is appropriately adjusted along the direction of the optical axes from a light incidence part of the LEDs 7 and, in this way, the luminance distribution is devised to become uniform. In the case of FIG. 6, there are arranged patterns in which the density in the light incidence part is somewhat low, that in a center part is somewhat high, and that in the edge part is the highest. The graph shown in the bottom of FIG. 6 indicates the luminance distribution of light transmitted through the contrast patterns corresponding to the position of the optical element 2. These contrast patterns are formed by adding diffusive corrugated surfaces, concave micro lenses, convex micro lenses, prisms, truncated cones, cones, printed patterns, or the like on the back face of the optical element 2 constituted of a diffuser panel, a clear plate, a board with an optical film pasted thereon, a polarizing component, or the like. Alternatively, notches, slits, round holes, oval holes, or holes of a prescribed shape may be provided in an optical functional film having one or more functions such as reflection, shading, transmission, and propagation of light, or gradation processing, micromachining, microscopic precision machining, pattern printing, or the like may be performed therein. In this way, it is possible to freely control the luminance distribution of the emitted light from the optical element 2.

The illumination device according to the present embodiment is one characterized in that, by intentionally forming brightness/darkness differences in luminance in the interior of the backlight blocks thereof and spreading luminance non-uniformities all over, linear or lattice-shaped bright (or dark) luminance portions at the borders of the backlight blocks are mitigated, that is are made difficult to be visually recognized. By combining the configurations of FIG. 6 and FIG. 4, it is possible to implement excellent display quality of little change in luminance since it is possible to implement a configuration where seams between the backlight blocks are not formed near the center where sensitivity of a human to variations in luminance is high. The example shown in FIG. 6 is a configuration example in which the dark luminance parts 41 and the intermediate luminance parts 42 (somewhat darker compared to the bright luminance parts 40 and brighter compared to the dark luminance parts 41) are alternately arranged in the interiors of the backlight blocks 4. Namely, there are provided brightness/darkness differences in luminance in the interior of the backlight blocks 4 and the luminance differences with the bright luminance parts 40 on the borders of backlight blocks 4 are mitigated.

Also, this contrast pattern is a rectangular shape as shown in FIG. 7 and has rectangles arranged in a checkerboard fashion. At this point, it has a form or an arrangement in which the array pitch of rectangular-shaped bright parts gradually becomes narrower and the density becomes higher from the LEDs 7 toward the edge parts of the backlight blocks 4. Namely, the light is emitted with better efficiency as proceeding to the edge portion and the uniformity within the blocks is enhanced. Simultaneously hereto, in portions where luminance changes abruptly such as emission lines or dark lines in the proximity of the LEDs 7 or at the borders, patterns of a different type may be provided or the size of circular-shaped or oval-shaped patterns may be changed. With patterns of optimized sizes and shapes like this, the function of enhancing luminance uniformity and the function of making luminance differences inconspicuous are accommodated with each other. In this way, the light control component 9 is capable of gradually selecting light propagating through the space, bringing into the optical element 2, and controlling light emission to the liquid crystal panel 1.

Since luminance non-uniformities get blurred over the illumination device 3 as a whole including at the borders thereof by providing brightness/darkness differences in luminance in the interior of the backlight blocks 4 by the configuration of FIG. 6 and FIG. 7, the bright luminance parts at the borders of the backlight blocks 4 become difficult to visually recognize. Further, there is provided a shading component constituted of a shading sheet, a shading print, or the like together with the light control component 9 in the positions corresponding to the LEDs 7 so that direct light of the LEDs 7 is shaded and a part of the light is transmitted, reflected, or propagated to prevent hot spots from being created. At this point, even in the case where a minute leakage of light from the LEDs 7 occurs due to the reflective sheet being thin, the light is diffused in the brightness and darkness of the aforementioned checkerboard pattern and becomes inconspicuous.

Incidentally, the aforementioned brightness/darkness differences in luminance are not limited to being formed in the aforementioned optical element 2 or light control component 9, and it may be implemented by forming a pattern on the reflective sheet 19 and/or the optical sheet group 18.

Also, even though it is not illustrated, it is acceptable to form an oval-shaped intermediate luminance part in the interior of the backlight blocks 4. This intermediate luminance part is formed in the front face of the optical element 2 with a so-called rough surface (a coarse surface) such as a fine or dense corrugated surface. A plurality of this oval-shaped rough surface are arrayed in a direction of the optical element parallel to the array direction of LEDs 7 (the short-end direction of the optical element 2 in the present example) to form one intermediate luminance domain, and there are provided two or more of the domains in a direction perpendicular to the array direction of the LEDs 7 (the longitudinal direction of the optical element 2 in the present example). With this, this rough surface performs the function of increasing the amount of light that advances in the forward direction more than the surrounding surfaces, thereby producing bright luminance.

In the aforementioned embodiment, an element (hereinafter, called a “bright part conferral element”) for conferring bright parts to the front face of the optical element 2 (a diffuser panel), such as the aforementioned rough surface (the coarse surface), a corrugated surface, a prism surface, a concave lens, a convex lens, or the like is formed so as to extend on the front face of the diffuser panel in a direction parallel to the direction of the array of the LEDs 7 (the short-end direction of the optical element 2 in the present embodiment), and also, this bright part conferral element is arrayed in two or more units in a direction perpendicular to the direction of the array of the LEDs (in the present embodiment, in the long-end direction of the optical element 2 and the traveling direction of the light from the LEDs inside the optical element 2). Since with a configuration in this way it is possible to generate luminance differences (luminance non-uniformities) in the front face of the optical element 2 with a period shorter than the period of the bright luminance parts (or the dark luminance parts) in the border portions of the backlight blocks 4, the bright luminance parts (or the dark luminance parts) in the border portions of the backlight blocks 4 become difficult to be visually recognized.

Spacings between respective points of local maxima in luminance in two or more bright part conferral elements are preferably about 0.5 to 3 cm and, still further, it is preferable for the spacings between the local maxima to be twice or greater than the distance from the surface of the diffuser panel to the incidence surface of the optical sheet group 18 (the incidence surface of the optical sheet group arranged in the position closest to the diffuser panel). Also, it is more preferable that a difference in luminance between light passing through the bright part conferral elements and light emitted from portions other than the bright part conferral elements on the face of the diffuser panel is made to be 50% or more of a difference in luminance between light emitted from the bright luminance parts (or the dark luminance parts) in the border portions of the backlight blocks 4 and from portions other than the bright part conferral elements on the face of the diffuser panel. When the bright part conferral elements are formed to satisfy these conditions, it is possible to make the bright luminance parts (or the dark luminance parts) in the border portions of the backlight blocks 4 more inconspicuous.

Also, if the aforementioned element for diffusing light is provided in a direction perpendicular to the array direction of the LEDs 7 on the face of the diffuser panel, the bright luminance parts (or the dark luminance parts) in the borders of the backlight blocks 4 generated in a direction perpendicular to the array direction of the LEDs 7 (the horizontal direction in the sheet of paper of FIG. 2) become difficult to be visually recognized. Of course, the aforementioned element for diffusing light may be provided both in a direction parallel and a direction perpendicular to the array direction of the LEDs 7.

According to the configuration of the aforementioned embodiment, in a thin slim-block scheme illumination device capable of area control, it is possible to implement an enhancement of the luminance of the center part of the panel and energy conservation in the overall illumination device. Further, it becomes possible to make inconspicuous the bright luminance parts or the dark luminance parts between the boundaries of the backlight blocks 4, and it also becomes possible to make similarly inconspicuous the bright luminance parts or the dark luminance parts created inside the backlight blocks 4, other than at the aforementioned borders.

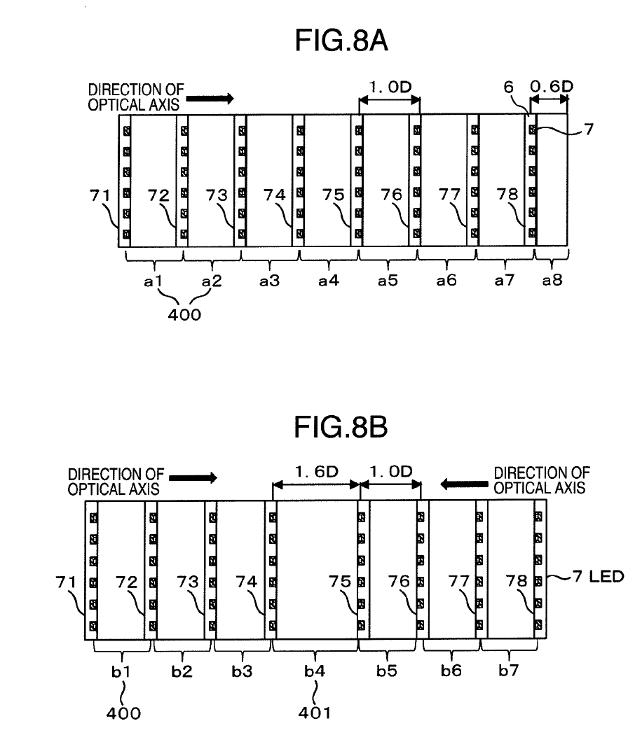

In FIG. 8A and FIG. 8B, there are shown plan views of a bidirectional/uneven pitch arrangement (FIG. 8B) according to the present embodiment and a unidirectional/even pitch arrangement (FIG. 8A) as a comparative example. In FIG. 8A and FIG. 8B, reference numerals 71 to 78 designate light source blocks. In the present embodiment, the width in the lateral direction of the backlight block b4 at the center part in the horizontal direction is set to be 1.6 D and an arrangement is so chosen that the directions of the optical axes of the light sources 7 oppose to each other with the center block as the boundary. As mentioned before, it would be actually preferable to make a bidirectional/uneven pitch arrangement in the longitudinal direction; in the present embodiment, however, for simplicity of explanation, the arrangement is made in the lateral direction. The directions of the optical axes are chosen to be the direction from Backlight Blocks a1 to a8 in the case of the unidirectional/even pitch arrangement of FIG. 8A and to be the directions from the left or the right to the center toward the bidirectional Backlight Block b4 in the case of the bidirectional/uneven pitch arrangement of FIG. 8B.

In the case of the unidirectional/even spacing shown in FIG. 8A, a configuration with eight blocks is chosen, and, in the case of the bidirectional/uneven pitch arrangement shown in FIG. 8B, a configuration with seven blocks is chosen. This is to match the total lengths of the two by choosing the configuration with seven blocks because the bidirectional backlight block 401 is chosen to have a size of 1.6 times that of other normal unidirectional backlight blocks 400 and a8 of the unidirectional backlight block 400 substantially has an effective length of about 0.6 D as shown in FIG. 8A since there are no LEDs 7 in the forward direction which supplement the amount of light by back scattering in the case of the unidirectional/even spacing pitch arrangement. Incidentally, in the case of FIG. 8B, the light source blocks 74 and 75 are arranged to oppose with each other on the both lateral sides of the bidirectional backlight block 401 and the total number of the light blocks becomes eight as well as that of FIG. 8A.

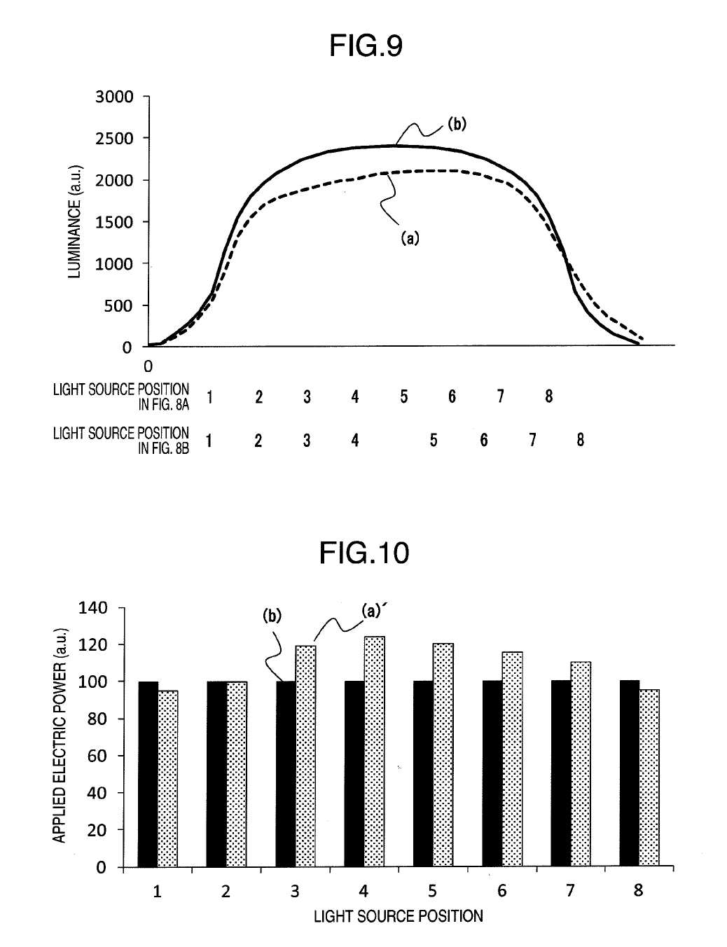

In FIG. 9, luminance characteristics are shown as a result of characteristics comparison. The positions of the light sources are shown in the abscissa; the position of a light source 7 of the light source block 71 in both FIG. 8A and FIG. 8B is rendered to be a reference and Light Source Position 1 through Light Source Position 8 are indicated depending on distances from Light Source Position 1 to respective light sources. In the case of the unidirectional/even pitch arrangement of FIG. 8A, since light from the LEDs 7 behind is accumulated toward the direction of the optical axes, the luminance is enhanced as moving to the right and the maximum value is reached between Backlight Block a5 and Backlight Block a6. On the other hand, in the case of the bidirectional/uneven pitch arrangement of FIG. 8B, since it is taken to be a symmetric arrangement with the Bidirectional Backlight Block b4 of the center part at the center, it yields a maximum value at the Bidirectional Backlight Block b4 of the center part. In other words, the distribution of emitted light of the illumination device 3 is substantially line symmetric with respect to a virtual line segment perpendicular to the emission axes of the light sources 7 and passing through the vicinity of the center of the illumination device 3. Since the human eyes tend to pay attention to the center and principal images often come in the vicinity of the center part in normal television images, a display apparatus with a bright center is perceived to be bright.

At the conditions of the present embodiment of the same input electric power, as compared by the center luminance, the bidirectional/uneven pitch arrangement of FIG. 8B is enhanced in luminance by 18% with respect to the unidirectional/even pitch arrangement of FIG. 8A. Meanwhile, even when compared by the peak luminance, the luminance is enhanced by 11%.

According to the present embodiment, because it is possible to make the luminance distribution nearly line symmetric with respect to the center, it is possible to implement an enhancement of the center luminance without increasing the input electrical power. Also, in the case of a constant center luminance, it is possible to implement a great reduction in electric power consumption. That is, with a simple configuration of not using a light guide plate, which is necessary in a conventional optics system for obtaining an area light source, it becomes possible to make the luminance distribution of an illumination device nearly symmetric in the direction of the optical axes and to effectively enhance luminance in the vicinity of the center with a facing arrangement utilizing the asymmetry of the light distribution of the LED light sources of a side-view structure and an uneven pitch arrangement.

### Embodiment 2

As for a method of implementing line symmetry in the luminance distribution with respect to the center of an illumination device, it is not necessary to stick to a method of the opposing arrangement of the LEDs 7 and it is also possible to implement with a method of controlling the electric power input to the respective backlight blocks for each block. The details thereof becomes clear by the following description.

FIG. 10 is an explanatory diagram showing the applied electric power for each backlight block of an illumination device according to the present embodiment. The used backlight configuration is to be the unidirectional/even pitch arrangement of FIG. 8A and the characteristics of the applied electric power thereof is to be (a)′. The bidirectional/uneven pitch arrangement of FIG. 8B used in Embodiment 1 was used for comparison and the characteristics of the applied electric power thereof is to be (b).

In the unidirectional/even pitch arrangement of FIG. 8A which is the present embodiment using the applied electric power characteristics (a)′, while setting the peak of the input electric power to Light Source Positions 3 and 4, which are toward upstream of the optical axis than Light Source Positions 4 and 5 of the center part, the applied electric power to the light sources of Light Source Position 8 is set to be smaller than the applied electric power to the light sources of Light Source Position 1. Incidentally, in the present embodiment, as a method of changing the applied electric power to the light sources 7, a pulse width of power-up is controlled. Although not described in FIG. 10, instead of controlling the applied electric power to the light sources 7, it is possible to implement the same luminance distribution with the method of controlling the arrangement pitch of the light sources 7. In the characteristics (a)′ of FIG. 10, by reducing the distance to adjacent light sources for the light sources 7 for which the applied electric power is high and by setting the distance to adjacent light sources to be greater for the light sources 7 for which the applied electric power is set low, the same effect can be obtained even when the applied electric power to each of the light sources is set uniform. The method of controlling the arrangement pitch and the method of controlling the applied electric power for each backlight block may be used together with each other.

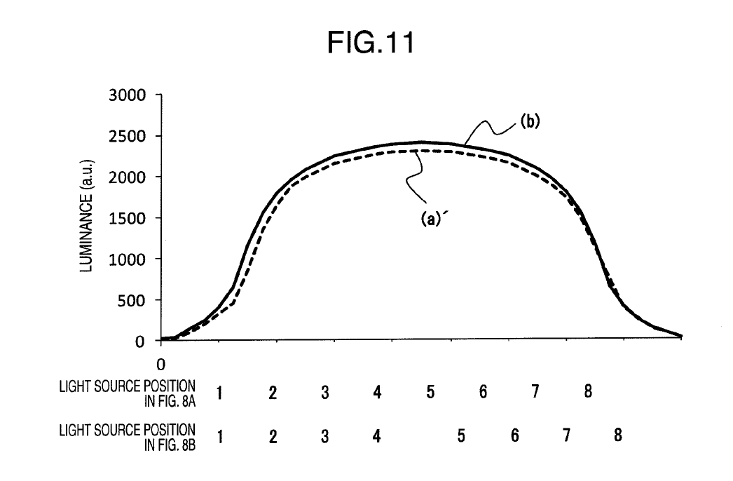

In FIG. 11, there are shown characteristics of the light output as the illumination device according to the present embodiment. The positions of the light sources are shown in the abscissa; the position of a light source 7 of the light source block 71 in both FIG. 8A and FIG. 8B is rendered to be a reference and Light Source Position 1 through Light Source Position 8 are indicated depending on distances from Light Source Position 1 to respective light sources. The light output characteristics (a)′ according to the present embodiment and (b) for the case of the bidirectional/uneven pitch arrangement as a comparative example are shown with respect to the positions of the light source blocks on the abscissa. Light Source Position 1 corresponds to the position of Light Source Block 71 in FIG. 8A and Light Source Position 7 corresponds to the position of Light Source Block 77 in FIG. 8A in sequence. As shown in (b) of FIG. 9 shown for Embodiment 1, a horizontal symmetry in the light output as the illumination device is obtained. In the present embodiment, since enhancement effect of the amount of light from the forward direction due to the facing arrangement as observed in Embodiment 1 is not seen, the peak luminance does not reach that of Embodiment 1; however, an effect of enhancement of the peak luminance equivalent to 12% of the input power to the entire of the illumination device is obtained.

Either of the embodiments of the present invention described so far is suitable for a backlight illumination device for use in a liquid crystal display apparatus; it is needless to say that it can be applied to general illumination apparatuses as well. By applying to a general illumination apparatus, for a ceiling illumination, for example, the present embodiments can be put into practical use effectively as a means of homogenizing the emitted light from a lamp cover or the intensity of illumination on a floor or compensating for a bias in light distribution in the case of using side-view LED light sources.

It should be further understood by those skilled in the art that although the foregoing description has been made on embodiments of the invention, the invention is not limited thereto and various changes and modifications may be made without departing from the spirit of the invention and the scope of the appended claims.

1. An illumination device comprising:
a plurality of light sources having axes of light emission in a direction parallel to a plane of light irradiation of the illumination device, arrayed in a direction perpendicular to the axes of light emission;
a reflective component reflecting emitted light from the plurality of the light sources;
an optical element of a plate shape, arranged to be separated by air from the reflective component and guiding light from the plurality of the light sources toward the plane of light irradiation;
a light control component, provided on a back surface or a front surface of the optical element, and controlling or adjusting an amount of light emission from the plurality of the light sources; and
a plurality of backlight blocks, the plurality of the backlight blocks being configured by being juxtaposed in a plane direction of the illumination device, the plurality of the backlight blocks comprising a bidirectional backlight block;
wherein the light sources are formed on both lateral sides of the bidirectional backlight block in a direction of the axes of emission of the light sources;
wherein the light sources formed on one lateral side of the bidirectional backlight block are arranged so that light is emitted therefrom in a direction toward the light sources formed on another lateral side of the bidirectional backlight block;
wherein the light sources formed on the other lateral side of the bidirectional backlight block are arranged so that light is emitted therefrom in a direction toward the light sources formed on the one lateral side of the bidirectional backlight block; and
wherein the bidirectional backlight block is arranged in a center part of the illumination device in a direction of the axes of emission of the light sources.

2. The illumination device according to claim 1, wherein the plurality of the backlight blocks further comprise a unidirectional backlight block;
wherein the light sources are formed on both lateral sides of the unidirectional backlight block in a direction of the axes of emission of the light sources;
wherein the light sources formed on one lateral side of the unidirectional backlight block are arranged so that light is emitted therefrom in a direction toward the light sources formed on another lateral side of the unidirectional backlight block;
wherein the light sources formed on the other lateral side of the unidirectional backlight block are arranged so that light is emitted therefrom in an opposite direction to a direction toward the light sources formed on the one lateral side of the unidirectional backlight block; and
wherein 2 D>D_{c}>D is satisfied where a pitch of arrangement of the light sources in the bidirectional backlight block is D_{c} and a pitch of arrangement of the light sources in the unidirectional backlight block is D.

3. The illumination device according to claim 2, wherein 1.6 D>D_{c}>1.2 D is satisfied.

4. An illumination device comprising:
a plurality of light sources having axes of light emission in a direction parallel to a plane of light irradiation of the illumination device, arrayed in a direction perpendicular to the axes of light emission;
a reflective component reflecting emitted light from the plurality of the light sources;
an optical element of a plate shape, arranged to be separated by air from the reflective component and guiding light from the plurality of the light sources toward the plane of light irradiation;
a light control component, provided on a back surface or a front surface of the optical element, and controlling or adjusting an amount of light emission from the plurality of the light sources; and
a plurality of backlight blocks, the plurality of the backlight blocks being configured by being juxtaposed in a plane direction of the illumination device; and
wherein a distribution of emitted light of the illumination device is made to be line symmetric with respect to a virtual line segment perpendicular to the axes of emission of the light sources and passing through a center of the illumination device by changing respective amounts of emitted light of the plurality of the backlight blocks.

5. The illumination device according to claim 4, wherein the respective amounts of emitted light of the plurality of the backlight blocks by changing either a number of the light sources arranged in a direction perpendicular to the axes of emission of the light sources or applied electric power to the light sources constituting each of the plurality of the backlight blocks.

6. The illumination device according to claim 5, wherein a pulse width of power-on is controlled to change the applied electric power to the light sources.

7. The illumination device according to claim 1, wherein optical patterns of bright luminance parts, dark luminance parts, and intermediate luminance parts are arranged on the back surface or the front surface of the optical element corresponding to each of the plurality of the backlight blocks.

8. The illumination device according to claim 1, wherein the reflective component comprises a flat portion and 5 Lₕ>h>1.2 Lₕ is satisfied where a distance between the optical element and the flat portion of the reflective component is h and a height of the light sources is Lₕ.

9. The illumination device according to claim 1, further comprising a light source substrate on which the light sources are mounted, the light sources being mounted on an edge portion of the light source substrate in a direction of the axes of emission of the light sources.

10. The illumination device according to claim 9, wherein the reflective component comprises an inclined portion which is inclined from a top surface of the light source substrate toward a bottom surface of the illumination device.

11. A liquid crystal display device comprising a liquid crystal panel and the illumination device according to claim 1.
